(19) United States
(12) Patent Application Publication
(10) Pub. No.: US 2013/0163516 A1
(43) Pub. Date: Jun. 27, 2013

(54) MARITIME COMMUNICATION SYSTEM AND METHOD

(71) Applicant: Electronics and Telecommunications Research Institute, Daejeon (KR)

(72) Inventors: Seung Kwon BAEK, Daejeon (KR); Dae Ho KIM, Daejeon (KR); Nam Hoon PARK, Daejeon (KR)

(73) Assignee: Electronics and Telecommunications Research Institute, Daejeon (KR)

(21) Appl. No.: 13/728,111

(22) Filed: Dec. 27, 2012

(30) Foreign Application Priority Data
Dec. 27, 2011 (KR) 10-2011-0143001

(51) Int. Cl. H04W 84/18

(52) U.S. Cl. 370/328

(57) ABSTRACT

Provided is a maritime communication system and method. A ship station of the maritime communication system may receive, from a maritime broadcast base station, maritime configuration information that includes setting information of shore base stations and setting information of maritime ship stations, may establish a radio link when a radio link configurable shore base station is present, may set the radio link through a radio link configurable neighbor ship station when the radio link configurable shore base station is absent, and may establish the radio link with an internal maritime satellite (INMARSAT) or a maritime very small aperture terminal (MVSAT) when the radio link configurable shore base station is absent and when the radio link configurable neighbor ship station is absent.

### CROSS-REFERENCE TO RELATED APPLICATION

This application claims the priority benefit of Korean Patent Application No. 10-2011-0143001, filed on Dec. 27, 2011, in the Korean Intellectual Property Office, the disclosure of which is incorporated herein by reference.

### BACKGROUND

1. Field of the Invention

The present invention relates to an access method of a shore base station using various radio communication technologies at sea, a method of providing an Internet service using a neighbor ship station, and a technology of providing a procedure.

2. Description of the Related Art

Currently, with the introduction of a Global Maritime Distress and Safety System (GMDSS), competitive development of strategies and definitions among countries for e-Navigation in the shipbuilding industry and marine equipment industry has become a global issue. e-Navigation is an electronic method to improve a navigation between ports, a relevant service, and safety and security at sea, and to protect a maritime environment according to a reported submitted by the International Association of Lighthouse Authorities. e-Navigation collects, integrates, exchanges, expresses, and analyzes maritime information harmoniously both at sea and in port.

Maritime radio communication places the highest importance on recognizing, tracking, and monitoring functions for safety of a ship, and provides a service such as an e-mail, a short message service (SMS), and the like. For the above operation, a current maritime communication provides a radio communication service using a very high frequency (VHF) band and a medium frequency (MF)/high frequency (HF) band, and provides a maritime communication service using a maritime very small aperture terminal (MVSAT).

The maritime radio communication using the VHF band has introduced and thereby been employing an automatic identification system (AIS), and aims to receive and process navigation related information such as a location, a heading, a speed, and the like that are automatically transmitted by a ship while out at sea, and to relay the processed navigation related information to another ship, so as to assure maritime traffic safety of the coastal waters and support a maritime traffic control within a harbor and search and rescue activities of ships in distress. The AIS used for the above purposes operates based on a self-organized time division multiple access (SOTDMA) at 156 megahertz (MHz) and 162 MHz of the VHF band, and provides a transmission rate of maximum 9.6 kilobits per second (kpbs). A transmission distance is within a range of 30 kilometers (km).

The MF/HF band may be employed for a far-field data transmission in a case where no ships are within the range of 30 km corresponding to the transmission distance of the VHF band. Currently, a PACTOR-III modem developed in Germany is being widely used as an HF band modem. The PACTOR-III modem provides a transmission distance of about 4,000 km to 40,000 km. The PACTOR-III modem supports a transmission rate of maximum 9.6 kbps using a frequency shift keying (FSK) scheme. When the transmission distance is beyond the maximum distance of 40,000 km, a WinLink service using a base station of another country is supported.

Use of the MVSAT, as a next generation ultra-high speed satellite communication system for ships capable of replacing an internal maritime satellite (INMARSAT), may provide a communication service at a maximum transmission rate of 1 megabit per second (Mbps), that is, a ultra-high communication rate of a ground level. Accordingly, the crew or passengers may utilize an Internet service on a ship at sea in a manner similar to being in port.

In addition to the aforementioned technical descriptions, various types of maritime communication systems have been developed to provide a wireless Internet service at sea. The various types of developed maritime communication systems are mixed up and thereby employed. In particular, a TRITON project of Singapore is conducting research on configuring a mesh network using an Institute of Electrical and Electronics Engineers (IEEE 802.16) wireless interoperability for microwave access (WiMAX) system, and on providing a high speed Internet service for ship-to-ship communication and ship-to-shore communication using the mesh network.

The various types of aforementioned maritime radio communication technologies have disadvantages in providing a service, such as an Internet service provided in port, while out at sea. The AIS using the VHF band is used for the maritime traffic safety and has some issues in terms of purpose of use, such as an inability to provide the Internet service due to a significantly low transmission rate. Also, the PACTOR-III modem using the MH/HF band has an advantage in that service coverage is wide, but has a disadvantage in that various multimedia services may not be provided due to a narrow bandwidth. The Internet service using a satellite such as the INMARSAT or the MVSAT may be quite costly and thus, may have some constraints in providing a universal Internet service. Also, a method of using the IEEE 802.16 WiMAX system, as proposed in the TRITON project, in order to provide an Internet service to a ship in port and ships in the coastal waters may have some constraints in providing a service when configuring a maritime radio network using a radio access technology (RAT) of a different standard for each region and country.

### SUMMARY

An aspect of the present invention provides a procedure and method that enables a ship station out at sea to establish a radio link using information of a shore base station and a neighbor ship station, and to utilize a wireless Internet service.

Another aspect of the present invention also provides a method of providing an efficient Internet service by configuring a radio link adaptive to a communication environment using a software defined radio (SDR) technology currently in the spotlight and a relay technology between communication nodes.

According to an aspect of the present invention, there is provided a maritime configuration server of a maritime communication system, including: a communication unit to receive setting information of shore base stations and setting information of maritime ship stations; a database to store and manage maritime configuration information that includes the setting information of the shore base stations and the setting information of the maritime ship stations; and a controller to control the maritime configuration information to be periodically broadcasted through a maritime broadcast base station.

According to another aspect of the present invention, there is provided a ship station of a maritime communication system, including: a global positioning system (GPS) to receive a satellite navigation signal in order to verify a location and a synchronization of a ship; a maritime configuration information receiver to receive, from a maritime broadcast base station, maritime configuration information that includes setting information of shore base stations and setting information of maritime ship stations, and to communicate with neighbor ship stations; a radio communication unit to establish a radio link using at least one radio access technology (RAT); and a controller to search for a radio link configurable shore base station based on the maritime configuration information, and to control the radio communication unit to establish the radio link when the radio link configurable shore base station is present.

According to still another aspect of the present invention, there is provided a ship station that operates as a repeater in a maritime communication system, including: a GPS to receive a satellite navigation signal in order to verify a location and a synchronization of a ship; a maritime configuration information receiver to receive, from a maritime broadcast base station, maritime configuration information that includes setting information of shore base stations and setting information of maritime ship stations, and to communicate with neighbor ship stations; a radio communication unit to establish a radio link using at least one RAT; and a controller to control the radio communication unit to establish the radio link with a neighbor ship station when a relay request is received from the neighbor ship station in a state where the radio link is established.

According to yet another aspect of the present invention, there is provided a method of providing a maritime communication service in a maritime configuration server of a maritime communication system, the method including: receiving setting information of shore base stations and setting information of maritime ship stations; storing and managing maritime configuration information that includes the setting information of the shore base stations and the setting information of the maritime ship stations; and periodically broadcasting the maritime configuration information through a maritime broadcast base station.

According to further another aspect of the present invention, there is provided a method of providing a maritime communication service in a ship station of a maritime communication system, the method including: receiving, from a maritime broadcast base station, maritime configuration information that includes setting information of shore base stations and setting information of maritime ship stations; searching for a radio link configurable shore base station based on the maritime configuration information; and establishing the radio link when the radio link configurable shore base station is present.

According to still another aspect of the present invention, there is provided a method of providing a maritime communication service in a ship station of a maritime communication system, the method including: receiving a candidate measurement request message from a neighboring ship station in a state where a radio link is established; generating a candidate measurement response message that includes the measurement result of a channel quality, and transmitting the candidate measurement response message to the neighbor ship station; and relaying the radio link establishment by establishing the radio link with the neighbor ship station when a relay request is received from the neighbor ship station.

According to embodiments of the present invention, there is proposed a method of broadcasting location and installation information of functional nodes, for example, a shore base station and a ship station, included in a maritime communication system. Also, there is proposed the maritime communication system for efficiently providing a wireless Internet service using a relay function between ship stations. Various types of radio link establishment schemes may be provided based on a location of a ship station and thus, even the ship station may provide a high speed Internet service. In addition, by providing an SDR based radio access interface configuring method capable of adaptively operating in a communication environment, various types of RATs may flexibly operate on a single platform.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a maritime communication system for maritime communication according to an embodiment of the present invention;

FIG. 2 is a block diagram illustrating a configuration of a maritime configuration server and a maritime broadcast base station according to an embodiment of the present invention;

FIG. 3 is a block diagram illustrating a configuration of a ship station according to an embodiment of the present invention;

FIG. 4 is a table illustrating an example of setting information of a shore base station managed by a maritime configuration server according to an embodiment of the present invention;

FIG. 5 is a table illustrating an example of setting information of a ship station managed by a maritime configuration server according to an embodiment of the present invention;

FIG. 6 is a flowchart illustrating a process of broadcasting, by a maritime configuration server, maritime configuration information according to an embodiment of the present invention;

FIG. 7 is a flowchart illustrating a process of establishing, by a ship station, a radio link according to an embodiment of the present invention;

FIG. 8 is a flowchart illustrating a process of establishing, by a ship station, a radio link with a neighbor ship station according to an embodiment of the present invention;

FIG. 9 is a flowchart illustrating a process of relaying, by a ship station, a establishment of a radio link to a ship station according to an embodiment of the present invention; and

FIG. 10 is a flowchart illustrating a process of updating, by a ship station, establishment of a radio link according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The present invention proposes a procedure and a method that enables a ship station out at sea to establish a radio link using information of a shore base station (BS) and a neighbor ship station, and to utilize a wireless Internet service. For the above purpose, the present invention proposes a method of managing location and setting information of a shore BS and a ship station using the following basic system and procedure, and transferring the location and setting information, and a procedure of establishing, by the ship station, a radio link for an Internet service using the received setting information. The radio link establishment procedure proposed herein will be described based on a case where an accessible shore BS is present and a case where the accessible shore BS is absent. In particular, in a case where the accessible shore BS is absent, the description will be made based on a method of utilizing a neighbor ship station and an access method using an existing satellite or PACTOR-III modem. For this, the present invention proposes a method capable of adaptively changing a radio access scheme based on a communication environment by employing software defined radio (SDR) based software equipment, instead of using pre-configured hardware based equipment. Here, the term “SDR” indicates a radio transmitting and receiving apparatus capable of changing major radio characteristics such as a frequency range or a frequency modulation scheme, a radio output, and the like, in a software manner.

A radio link establishment scheme proposed herein may initially select a radio access scheme capable of providing a service at a high rate, such as a third generation partnership project (3GPP) long term evolution (LTE), worldwide interoperability for microwave access (WiMAX), and wireless fidelity (WiFi). When the aforementioned radio access schemes are unavailable, the radio link establishment scheme may employ, as default, an existing radio access scheme, for example, a satellite or a PACTOR-III modem, considered in maritime communication.

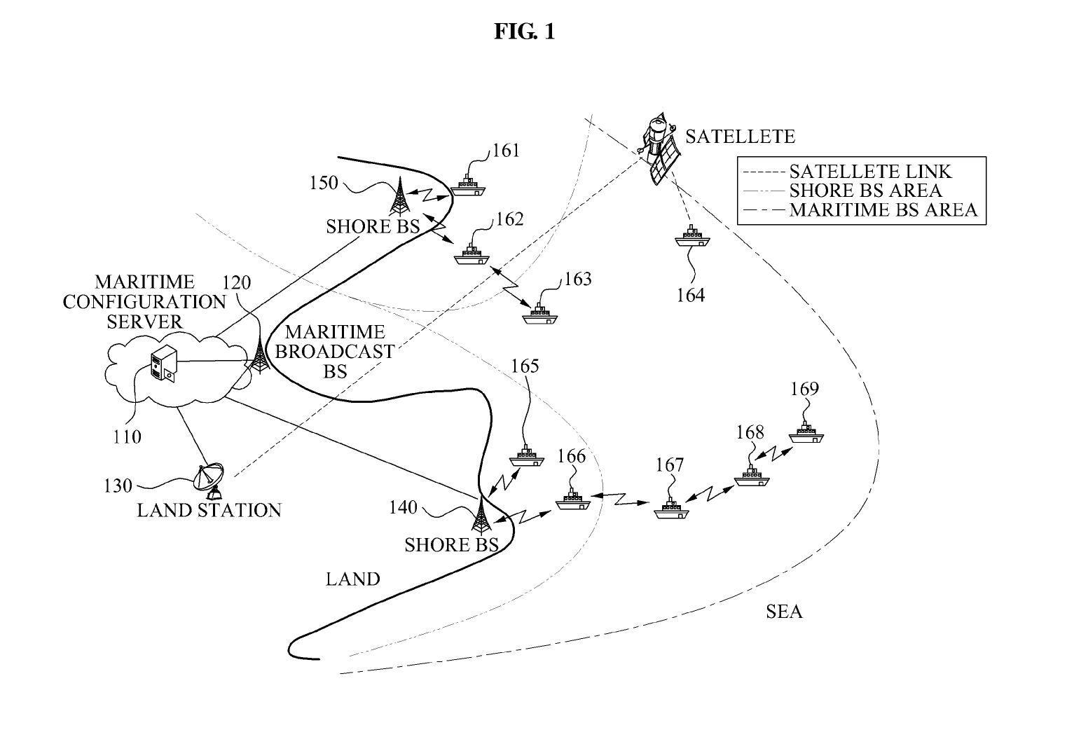

FIG. 1 is a diagram illustrating a configuration of a maritime communication system for maritime communication according to an embodiment of the present invention.

Referring to FIG. 1, in the configuration of the maritime communication system for maritime communication, shore BSs 140 and 150 for the maritime communication are installed in port or on the coast, a plurality of ship stations 161, 162, 163, 164, 165, 166, 167, 168, and 169 are sailing at sea or are anchored. Also, there are a satellite for providing a service and a land station 130 for communicating with the satellite. The satellite and the land station 130 may interact with each other over a provider network or an Internet network. The provider network or the Internet network may include a maritime configuration server 110 to manage location and setting information of the shore BSs 140 and 150, and location and setting information of the plurality of ship stations 161 to 169, and may interact with a maritime broadcast BS 120. The maritime broadcast BS 120 functions to periodically globally broadcast location and setting information of the shore BSs 140 and 150, and location and setting information of the plurality of ship stations 161 to 169 that is provided from the maritime configuration server 110. As described above, each of the ship stations 161 to 169 may establish various types of radio links using a shore land station, a neighbor ship station, and a PACTOR-III modem based on a communication environment by employing an SDR.

FIG. 2 is a block diagram illustrating a configuration of a maritime configuration server 110 and a maritime broadcast BS 120 according to an embodiment of the present invention.

Referring to FIG. 2, the maritime configuration server 110 may include a communication unit 210, a database 220, and a controller 230. The maritime broadcast BS 120 may include a broadcasting unit 240.

The communication unit 210 of the maritime configuration server 110 may receive setting information of shore BSs and setting information of maritime ship stations by performing a function of accessing a provider network or an Internet network.

The database 220 may store and manage maritime configuration information that includes the setting information of the shore BSs and the setting information of the maritime ship stations.

The controller 230 may control the maritime configuration information to be periodically broadcasted through the maritime broadcast BS 120.

When the setting information of the shore BSs and the setting information of the maritime ship stations is modified, the controller 230 may control the maritime configuration information stored in the database 220 to be updated.

When the maritime configuration information is received from the maritime configuration server 110, the broadcasting unit 240 of the maritime broadcast BS 120 may periodically broadcast the received maritime configuration information to cell coverage of the maritime broadcast BS 120 using a predetermined frequency, for example, an out-band channel.

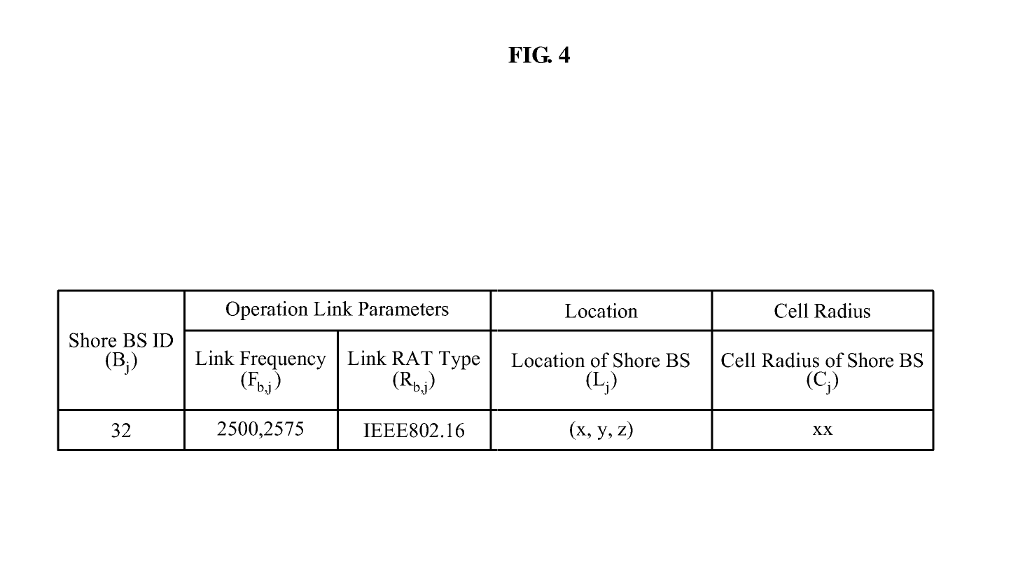

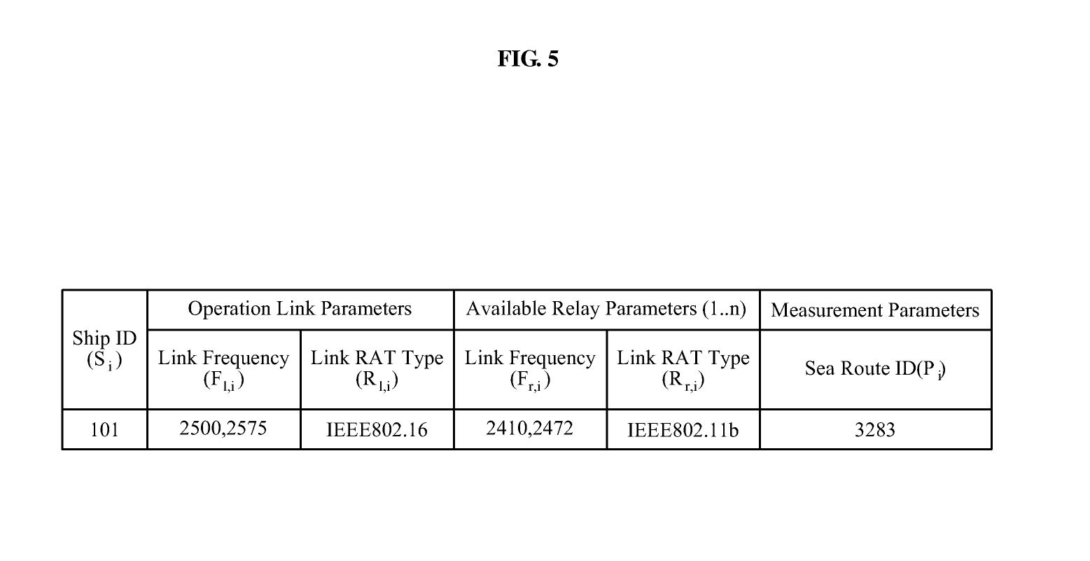

FIG. 4 is a table illustrating an example of setting information of a shore BS managed by a maritime configuration server according to an embodiment of the present invention.

Referring to FIG. 4, setting information of the shore BS may include information associated with at least one of a frequency of a radio link, that is, a link frequency, a type of a radio access technology (RAT), that is, a link RAT type used for establishing the radio link, a location of the shore BS, and cell coverage, that is, a cell radius of the shore BS.

FIG. 5 is a table illustrating an example of setting information of a ship station managed by a maritime configuration server according to an embodiment of the present invention.

Referring to FIG. 5, setting information of the maritime ship station may include information associated with at least one of a frequency of a radio link, that is, a link frequency, a type of a RAT, that is, a link RAT type used for establishing the radio link, a relay frequency, a type of an RAT used for relaying, and a sea route.

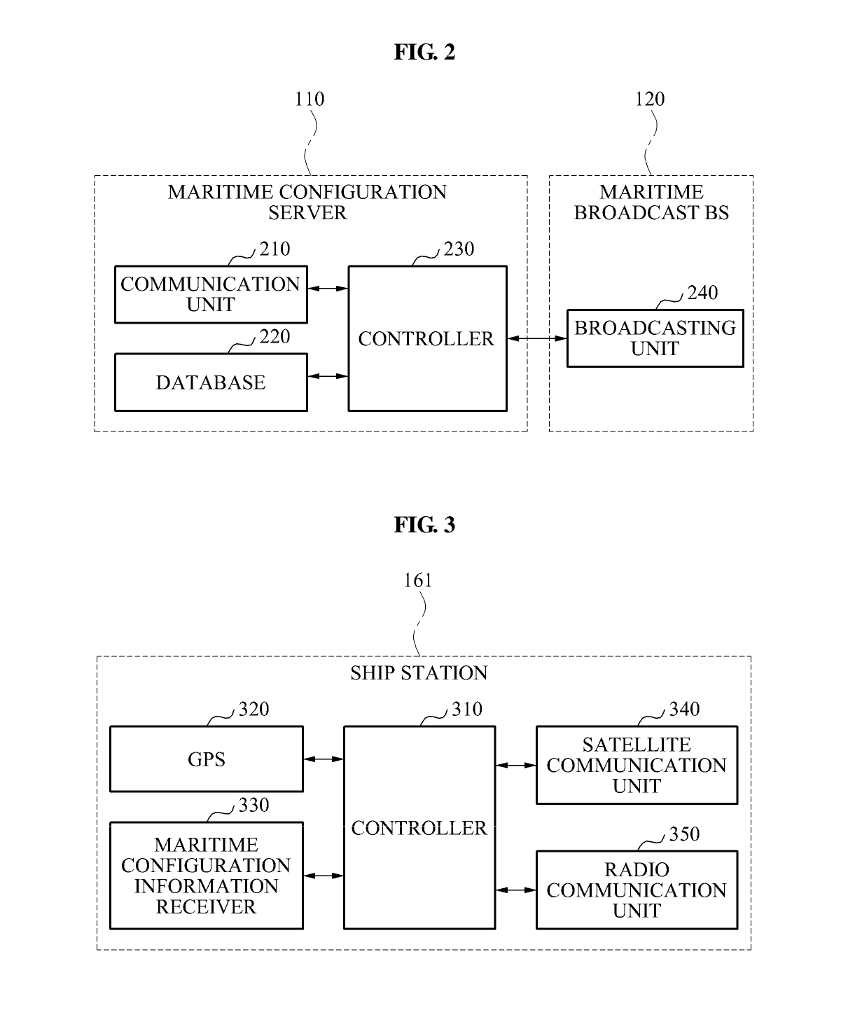

FIG. 3 is a block diagram illustrating a configuration of a ship station 161 according to an embodiment of the present invention.

Referring to FIG. 3, the ship station 161 may include a controller 310, a global positioning system (GPS) 320, a maritime configuration information receiver 330, a satellite communication unit 340, and a radio communication unit 350.

The GPS 320 may receive a satellite navigation signal to verify a location and a synchronization of a ship.

The maritime configuration information receiver 330 may receive, from a maritime broadcast BS, maritime configuration information that includes setting information of shore BSs and setting information of maritime ship stations, and may communicate with neighbor ship stations.

The satellite communication unit 340 may establish a radio link with an internal maritime satellite (INMARSAT) or a maritime very small aperture terminal (MVSAT).

The radio communication unit 350 may establish a radio link using at least one RAT. Here, the at least one RAT may include, for example, 3GPP LTE, WiMAX, WiFi, and the like.

The controller 360 may search for a radio link configurable shore BS based on the maritime configuration information, and may control the radio communication unit 350 to establish the radio link when the radio link configurable shore BS is present. Here, the radio link configurable shore BS indicates a shore BS in which the radio link may be established.

When the radio link configurable shore BS is absent, the controller 310 may search for a radio link configurable neighbor ship station. When the radio link configurable neighbor ship station is present, the controller 310 may control the radio communication unit 350 to establish the radio link through the radio link configurable neighbor ship station. Here, the radio link configurable neighbor ship station indicates a neighbor ship station in which the radio link may be established.

When controlling the radio communication unit 350 to establish the radio link through the radio link configurable neighbor ship station, the controller 310 may transmit, to neighbor ship stations, a candidate measurement request message requesting channel quality information, may receive, from each of the neighbor ship stations using the maritime configuration information receiver 330, a candidate measurement response message including the measurement result of a channel quality, and may control the radio link to be established through a neighbor ship station having a highest channel quality among the neighbor ship stations.

When the radio link configurable shore BS is absent, and when the radio link configurable neighbor ship station is absent, the controller 310 may control the satellite communication unit 340 to establish the radio link with the INMARSAT or the MVSAT.

When the radio link is established, the controller 310 may transmit, to the maritime configuration server 110 of FIG. 2, a connection setup report message indicating that the radio link is established.

Meanwhile, a ship station of which radio link establishment is completed may relay radio link establishment for a neighbor ship station.

When a relay request is received from the neighbor ship station in a state where the radio link is established, the controller 310 may control the radio communication unit 350 to establish the radio link with the neighbor ship station. In this instance, when a candidate measurement request message is received from the neighbor ship station through the maritime configuration information receiver 330 before establishing the radio link with the neighbor ship station, the controller 310 may transmit, to the neighbor ship station through the maritime configuration information receiver 330, a candidate measurement response message including the measurement result of a channel quality.

Hereinafter, a method of establishing, by a maritime communication system, a radio link of a ship station according to an embodiment of the present invention constructed as above will be described.

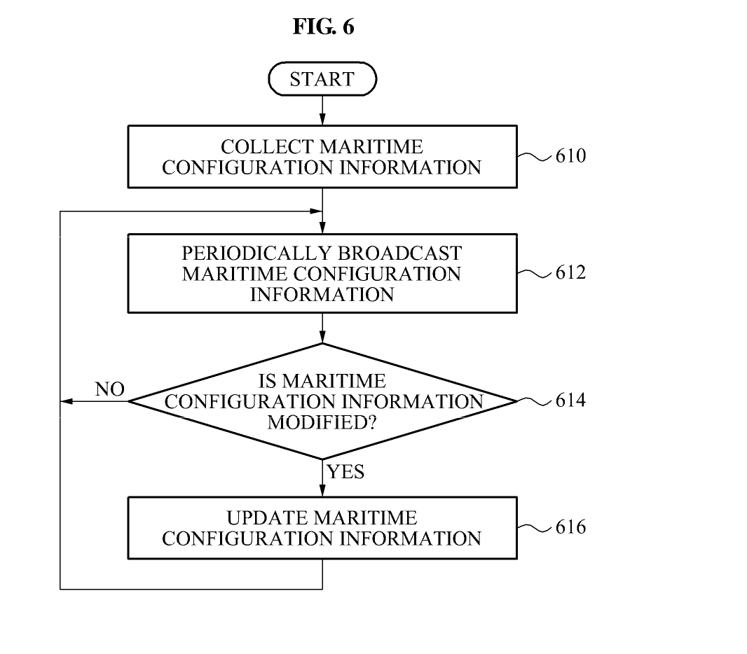

FIG. 6 is a flowchart illustrating a process of broadcasting, by a maritime configuration server, maritime configuration information according to an embodiment of the present invention.

In operation 610, the maritime configuration server may receive setting information of shore BSs and setting information of maritime ship stations.

In operation 612, the maritime configuration server may periodically broadcast maritime configuration information that includes the setting information of the shore BS and the setting information of the maritime ship stations, through a maritime broadcast BS.

In operation 614, the maritime configuration server may verify whether the setting information of the shore BSs and the setting information of the maritime ship stations is modified.

When the setting information of the shore BSs and the setting information of the maritime ship stations is not modified in operation 614, the maritime configuration server may return to operation 612.

On the contrary, when the setting information of the shore BSs and the setting information of the maritime ship stations is modified in operation 614, the maritime configuration server may update the maritime configuration information in operation 616 and then return to operation 612.

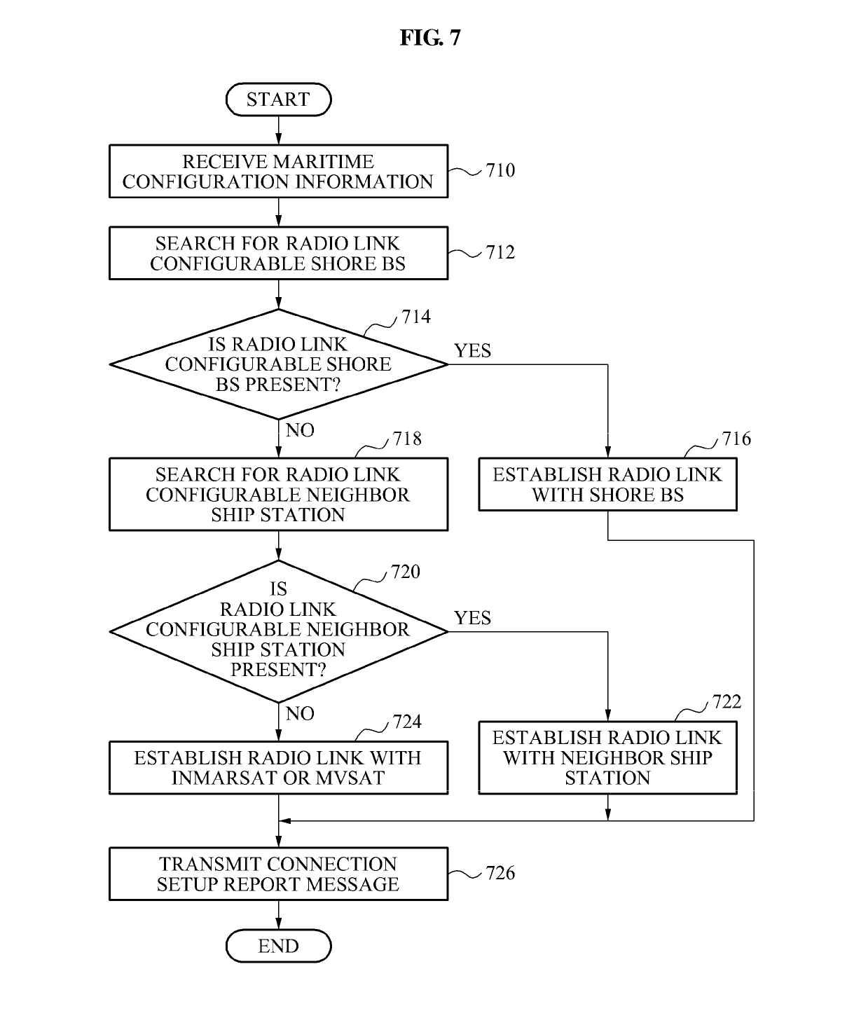

FIG. 7 is a flowchart illustrating a process of establishing, by a ship station, a radio link according to an embodiment of the present invention.

Referring to FIG. 7, in operation 710, the ship station may receive maritime configuration information that includes setting information of shore BSs and setting information of maritime ship stations through a maritime broadcast BS.

In operation 712, the ship station may search for a radio link configurable shore BS. A plurality of radio link configurable shore BSs may be present.

In operation 714, the ship station may verify whether at least one radio link configurable shore BS is present as the search result.

When at least one radio link configurable shore BS is present in operation 714, the ship station may select a shore BS with which the radio link is to be established and then establish the radio link with the selected shore BS in operation 716. In this instance, the selected shore BS may have the most excellent channel quality among the plurality of radio link configurable shore BSs.

On the contrary, when at least one radio link configurable shore BS is absent in operation 714, the ship station may search for a radio link configurable neighbor ship station in operation 718.

In operation 720, the ship station may verify whether at least one radio link configurable neighbor ship station is present.

When at least one radio link configurable neighbor ship station is present in operation 720, the ship station may select a neighbor ship station with which the radio link is to be established and then establish the radio link with the selected neighbor ship station. Here, the selected neighbor ship station may have the most excellent channel quality among radio link configurable neighbor ship stations.

On the contrary, when at least one radio link configurable neighbor ship station is absent in operation 720, the ship station may establish the radio link with an INMARSAT or an MVSAT in operation 724.

After performing operations 716, 722, and 724, the ship station may transmit, to a maritime configuration server, a connection setup report message indicating that the radio link is established in operation 726.

Meanwhile, when establishing the radio link in operations 716, 722, and 724, a different RAT may be employed. In this case, a communication interface may be reconfigured using a SDR technology.

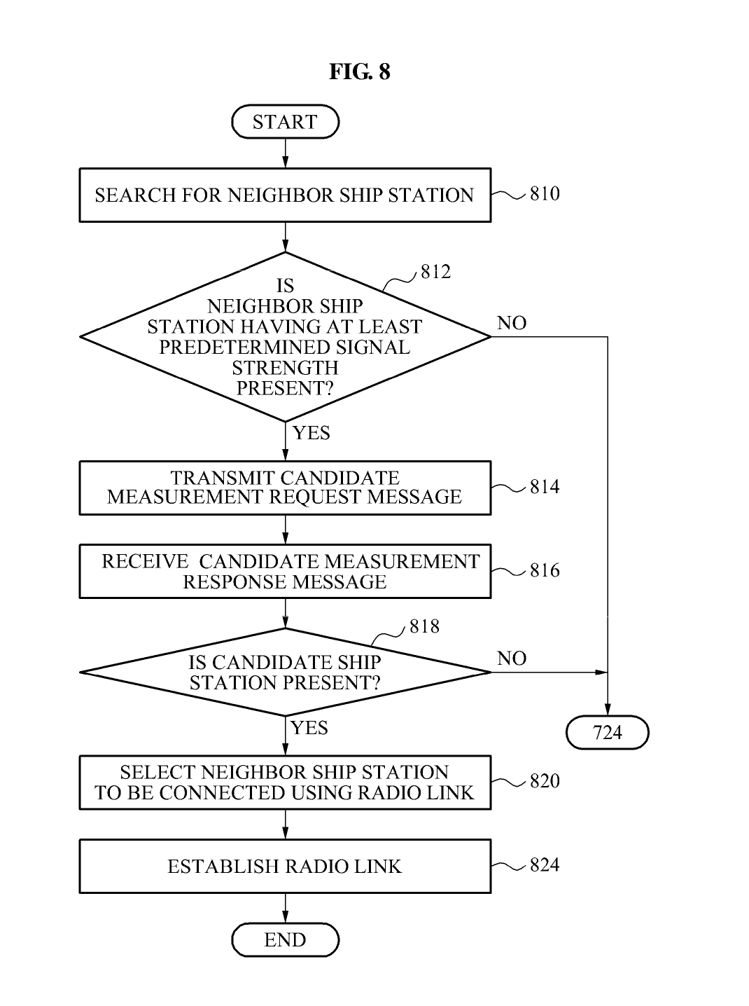

Operations 718, 720, and 722 of FIG. 7 will be further described with reference to FIG. 8.

FIG. 8 is a flowchart illustrating a process of establishing, by a ship station, a radio link with a neighbor ship station according to an embodiment of the present invention.

Referring to FIG. 8, in operation 810, the ship station may search for a neighbor ship station. More specifically, the ship station may measure signal strength from a neighbor ship station using Equation 1 and then search for a neighbor ship station of which signal strength is greater than or equal to a predetermined threshold.

PWR_{d}=Pₜ−L−10nlog(d)+f(μ, σ) [Equation 1]
Pₜ: transmitted power
L: constant power loss
n: path loss exponent
d: distance between ship and neighbor ship
f(μ, σ): shadow fading which as Gaussian with mean μ=0

In operation 812, the ship station may verify whether neighbor ship stations having signal strength greater than the predetermined threshold is present.

When the neighbor ship stations having the signal strength greater than the predetermined threshold are present in operation 812, the ship station may transmit, to each of the neighbor ship stations, a candidate measurement request message requesting channel quality information in operation 814.

In operation 816, the ship station may receive, from each of the neighbor ship stations, a candidate measurement response message including the measurement result of a channel quality.

In operation 818, the ship station may verify whether candidate ship stations having the channel equality greater than or equal to the predetermined threshold are present.

When the candidate ship stations having the channel quality greater than the predetermined threshold are present in operation 818, the ship station may select, from among the candidate ship stations, a neighbor ship station to be connected using the radio link. Here, the ship station may evaluate neighbor ship stations included in the candidate ship stations using Equation 2, Equation 3, and Equation 4, and may select, as the neighbor ship station to be connected using the radio link, a neighbor ship station having the highest evaluation result.

$$\begin{matrix}{\overline{U}}_{s} = α {U}_{s , snr} + ( 1 - α ) {U}_{s , load} \\ where \\ 0 \leq α \leq 1 {U}_{s , snr} \text{:} Utility function for S N R \text{/} R S S I \\ {U}_{s , load} \text{:} Utility function for Load \\ α , β \text{:} weight factor & [ Equation 2 ] \\ {U}_{s , snr} = \{ \begin{matrix}1 , & if {M}_{s , snr} \geq {SNR}_{th} \\ \frac{{M}_{s , snr}}{{SNR}_{s , th}} , & otherwise\end{matrix} \\ {M}_{s , snr} \text{:} Measured S N R \text{/} R S S I & [ Equation 3 ] \\ {U}_{s , load} = 1 - {M}_{s , load} \\ where \\ 0 \leq {M}_{s , load} \leq 1 \\ {M}_{s , load} \text{:} Measured Load & [ Equation 4 ]\end{matrix}$$

When the neighbor ship station to be connected using the radio link is selected in operation 820, the ship station may establish the radio link with the selected neighbor ship station in operation 824.

When establishing the radio link in operation 824, a different RAT may be employed. In this case, a communication interface may be reconfigured using an SDR technology.

When the neighbor ship stations having the signal strength greater than the predetermined threshold are absent in operation 812, or when the candidate ship stations having the channel quality greater than the predetermined threshold are absent in operation 814, the ship station may perform operation 724 of FIG. 7.

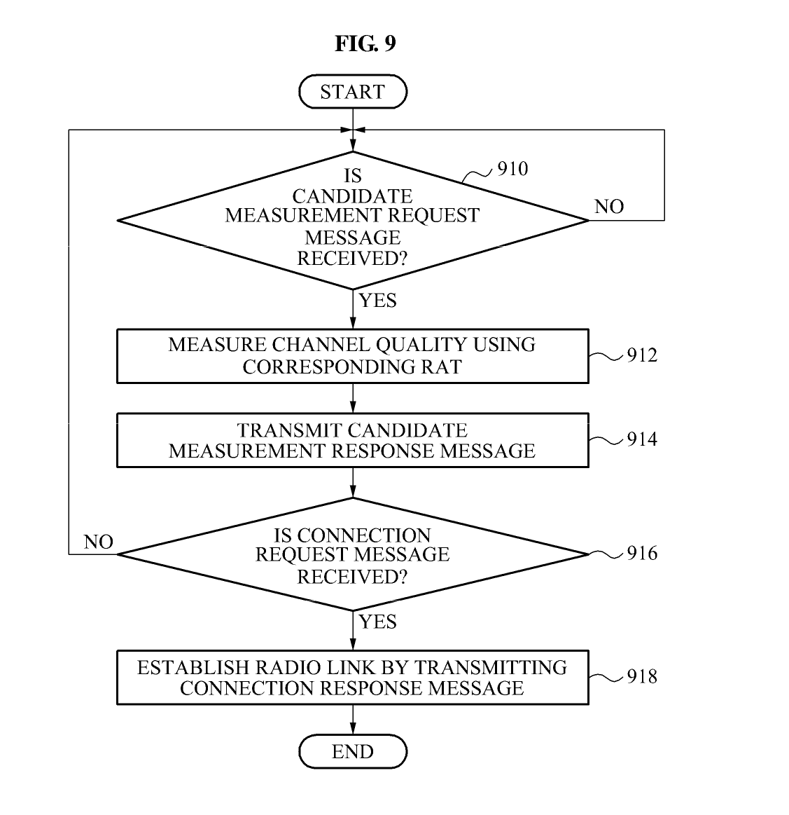

FIG. 9 is a flowchart illustrating a process of relaying, by a ship station, establishment of a radio link to a ship station according to an embodiment of the present invention.

Referring to FIG. 9, when a candidate measurement request message requesting channel quality information is received from a neighbor ship station in a state where a radio link is established in operation 910, the ship station may measure a channel quality with the neighbor ship station using a corresponding RAT in operation 912.

In operation 914, the ship station may transmit, to the neighbor ship station, a candidate measurement response message that includes a channel quality measurement result.

In operation 916, the ship station may verify whether a connection request message requesting relay of a radio link establishment is received from the neighbor ship station.

When the connection request message is received in operation 916, the ship station may transmit a connection response message and establish the radio link with the neighbor ship station in operation 918.

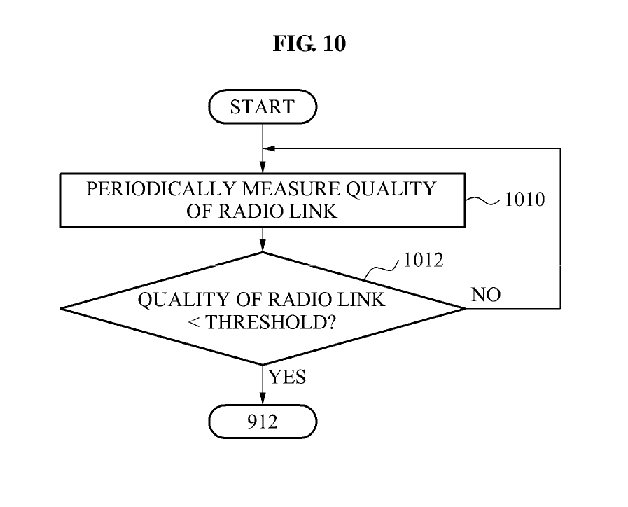

FIG. 10 is a flowchart illustrating a process of updating, by a ship station, establishment of a radio link according to an embodiment of the present invention.

Referring to FIG. 10, in operation 1010, the ship station may periodically measure quality of a radio link when the radio link is established.

In operation 1012, the ship station may verify whether the quality of the radio link is less than a predetermined threshold.

When the quality of the radio link is less than the predetermined threshold in operation 1012, the ship station may determine that it is difficult to utilize a communication service using the corresponding radio link and then perform operation 912 of FIG. 9.

On the contrary, when the quality of the radio link is greater than or equal to the predetermined threshold in operation 1012, the ship station may return to operation 1010 and periodically measure the quality of the radio link.

The above-described exemplary embodiments of the present invention may be recorded in computer-readable media including program instructions to implement various operations embodied by a computer. The media may also include, alone or in combination with the program instructions, data files, data structures, and the like. The program instruction recorded in the media may be specially designed and configured for the invention, or may be known to those skilled in the art and thereby be employed.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A maritime configuration server of a maritime communication system, comprising:
a communication unit to receive setting information of shore base stations and setting information of maritime ship stations;
a database to store and manage maritime configuration information that comprises the setting information of the shore base stations and the setting information of the maritime ship stations; and
a controller to control the maritime configuration information to be periodically broadcasted through a maritime broadcast base station.

2. The maritime configuration server of claim 1, wherein when the setting information of the shore base stations and the setting information of the maritime ship stations is modified, the controller controls the maritime configuration information stored in the database to be updated.

3. The maritime configuration server of claim 1, wherein the controller controls the maritime configuration information to be transmitted to a ship station that is established with a radio link, through the radio link.

4. The maritime configuration server of claim 1, wherein the setting information of the shore base stations comprises information associated with at least one of a frequency of a radio link, a type of a radio access technology (RAT) used for establishing the radio link, a location of a shore base station, and cell coverage.

5. The maritime configuration server of claim 1, wherein the setting information of the maritime ship stations comprises information associated with at least one of a frequency of a radio link, a type of a RAT used for establishing the radio link, a relay frequency, a type of an RAT used for relaying, and a sea route.

6. A ship station of a maritime communication system, comprising:
a global positioning system (GPS) to receive a satellite navigation signal in order to verify a location and a synchronization of a ship;
a maritime configuration information receiver to receive, from a maritime broadcast base station, maritime configuration information that comprises setting information of shore base stations and setting information of maritime ship stations, and to communicate with neighbor ship stations;
a radio communication unit to establish a radio link using at least one radio access technology (RAT); and
a controller to search for a radio link configurable shore base station based on the maritime configuration information, and to control the radio communication unit to establish the radio link when the radio link configurable shore base station is present.

7. The ship station of claim 6, wherein when the radio link is established, the controller transmits, to a maritime configuration server, a connection setup report message indicating that the radio link is established.

8. The ship station of claim 6, wherein:
when the radio link configurable shore base station is absent, the controller searches for a radio link configurable neighbor ship station, and
when the radio link configurable neighbor ship station is present, the controller controls the radio communication unit to establish the radio link through the radio link configurable neighbor ship station.

9. The ship station of claim 8, wherein when controlling the radio communication unit to establish the radio link through the radio link configurable neighbor ship station, the controller transmits, to the neighbor ship stations, a message requesting candidate measurement requesting channel quality information, receives, from each of the neighbor ship stations using the maritime configuration information receiver, a candidate measurement response message including the measurement result of a channel quality, and controls the radio link to be established through a neighbor ship station having a highest channel quality among the neighbor ship stations.

10. The ship station of claim 8, further comprising:
a satellite communication unit to establish a radio link with an internal maritime satellite (INMARSAT) or a maritime very small aperture terminal (MVSAT),
wherein when the radio link configurable shore base station is absent, and when the radio link configurable neighbor ship station is absent, the controller controls the satellite communication unit to establish the radio link with the INMARSAT or the MVSAT.

11. The ship station of claim 6, wherein the setting information of the shore base stations comprises information associated with at least one of a frequency of a radio link, a type of a radio access technology (RAT) used for establishing the radio link, a location of a shore base station, and cell coverage.

12. The ship station of claim 6, wherein the setting information of the maritime ship stations comprises information associated with at least one of a frequency of a radio link, a type of a RAT used for establishing the radio link, a relay frequency, a type of an RAT used for relaying, and a sea route.

13. A ship station that operates as a repeater in a maritime communication system, comprising:
a global positioning system (GPS) to receive a satellite navigation signal in order to verify a location and a synchronization of a ship;
a maritime configuration information receiver to receive, from a maritime broadcast base station, maritime configuration information that comprises setting information of shore base stations and setting information of maritime ship stations, and to communicate with neighbor ship stations;
a radio communication unit to establish a radio link using at least one radio access technology (RAT); and
a controller to control the radio communication unit to establish the radio link with a neighbor ship station when a relay request is received from the neighbor ship station in a state where the radio link is established.

14. The ship station of claim 13, wherein when a candidate measurement request message is received from the neighbor ship station through the maritime configuration information receiver before establishing the radio link with the neighbor ship station, the controller transmits, to the neighbor ship station through the maritime configuration information receiver, a candidate measurement response message including the measurement result of a channel quality.

15. A method of providing a maritime communication service in a maritime configuration server of a maritime communication system, the method comprising:
receiving setting information of shore base stations and setting information of maritime ship stations;
storing and managing maritime configuration information that comprises the setting information of the shore base stations and the setting information of the maritime ship stations; and
periodically broadcasting the maritime configuration information through a maritime broadcast base station.

16. The method of claim 15, further comprising:
updating the maritime configuration information when the setting information of the shore base stations and the setting information of the maritime ship stations is modified.

17. A method of providing a maritime communication service in a ship station of a maritime communication system, the method comprising:
receiving, from a maritime broadcast base station, maritime configuration information that comprises setting information of shore base stations and setting information of maritime ship stations;
searching for a radio link configurable shore base station based on the maritime configuration information; and
establishing the radio link when the radio link configurable shore base station is present.

18. The method of claim 17, further comprising:
searching for a radio link configurable neighbor ship station when the radio link configurable shore base station is absent; and
establishing the radio link through the radio link configurable neighbor ship station when the radio link configurable neighbor ship station is present.

19. The method of claim 18, further comprising:
establishing a radio link with an internal maritime satellite (INMARSAT) or a maritime very small aperture terminal (MVSAT) when the radio link configurable shore base station is absent, and when the radio link configurable neighbor ship station is absent.

20. A method of providing a maritime communication service in a ship station of a maritime communication system, the method comprising:
receiving a candidate measurement request message from a neighboring ship station in a state where a radio link is established;
generating a candidate measurement response message that comprises the measurement result of a channel quality, and transmitting the candidate measurement response message to the neighbor ship station; and
relaying the radio link establishment by establishing the radio link with the neighbor ship station when a relay request is received from the neighbor ship station.
